(19) United States
(12) Patent Application Publication
(10) Pub. No.: US 2016/0021236 A1
(43) Pub. Date: Jan. 21, 2016

(54) Electronic Device and Method for Managing Modes of the Device

(71) Applicant: Google Technology Holdings LLC, Mountain View, CA (US)

(72) Inventor: Raghava Aditya Nukala, Bangalore (IN)

(21) Appl. No.: 14/336,502

(22) Filed: Jul. 21, 2014

(51) Int. Cl. H04M 1/725

(52) U.S. Cl. CPC H04M 1/72566; H04M 1/72569; H04M 2250/12

(57) ABSTRACT

An apparatus and a method in an electronic device for managing modes are disclosed herewith. The electronic device retrieves a meeting time from a meeting event stored in a scheduling application of the electronic device. The electronic device further identifies connectivity identification information from the meeting event and changes the operating mode to a meeting mode in response to detecting usage of the connectivity identification information at the electronic device during the meeting time. The scheduling application may be a calendar application, notes, tasks, reminders, etc. The connectivity identification information may be a conference call number, a telephone number, a user identification information, a video conference, or a web link to a virtual meeting.

### FIELD OF THE DISCLOSURE

The present disclosure generally relates to electronic communication devices and more particularly to managing modes of operation of the electronic device.

### BACKGROUND

Advancements in electronic communication devices have greatly increased the versatility of their usage in today's world. Today's electronic devices are capable of operating in various modes such as a general mode, a meeting mode, an office mode, and other various customizable modes. While operating in a particular mode, the electronic device may have a different incoming call and message notification, sound level, display brightness, etc. Various attributes of the device can be set differently for each of these modes by a user of the electronic device. The electronic devices have evolved from simple mobile telephones and pagers into sophisticated devices that are capable of performing a variety of functionalities.

As the sophistication of mobile devices has increased, so has the expectations of the users for various intuitive functionalities provided by the device. One of such functionality is the capability of the electronic device to manage between various operating modes. No one likes to be disturbed while in a meeting. Conventional electronic devices are capable of putting the device in a meeting mode upon detecting a calendar event stored in a calendar application on the device. However, it is very much possible that the meeting may not start or end at the exact time mentioned in the calendar event. And therefore, the time for which the electronic device goes into the meeting mode will be incorrect causing significant inconvenience to the user of the device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of an exemplary electronic device in accordance with the present invention.

FIG. 2 is a block diagram showing example internal components of the electronic device in accordance with some embodiments of the present invention.

FIG. 3 is a flowchart illustrating an implementation of the electronic device in accordance with some embodiments of the present invention.

FIG. 4 is a flowchart showing example steps of another operation of the electronic device in accordance with some embodiments of the present invention.

FIG. 5 is a flowchart showing example steps of yet another operation of the electronic device in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

An apparatus and a method in an electronic device for managing modes are disclosed herewith. One aspect is a method which comprises retrieving a meeting time from a meeting event stored in a scheduling application of the electronic device. The method further includes identifying connectivity identification information from the meeting event and changing the electronic device to a meeting mode in response to detecting usage of the connectivity identification information at the electronic device during the meeting time. The scheduling application may be a calendar application, notes, tasks, reminders, etc.

Another aspect is an electronic device comprising a calendar module and a processor. The calendar module is configured to store meeting events including a meeting time. The processor is configured to retrieve the meeting time from the meeting event stored in the calendar module, identify connectivity identification information from the meeting event, and change the electronic device to a meeting mode in response to detecting usage of the connectivity identification information at the electronic device during the meeting time. The connectivity identification information may be a conference call number, a telephone number, a user identification information, a video conference, or a web link to a virtual meeting.

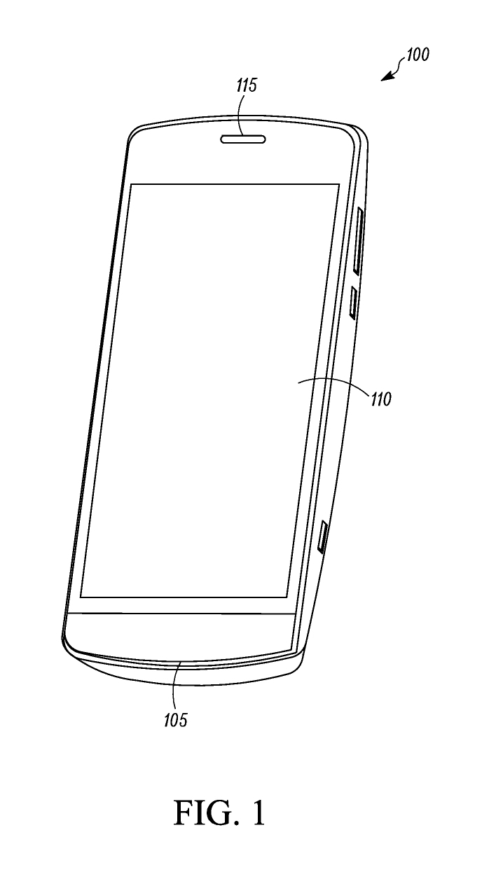

FIG. 1 is a perspective view of an exemplary electronic device in accordance with the present invention. The electronic device 100 may be a wireless mobile device. However, the electronic device 100 is intended to be representative of a variety of other electronic devices. In some embodiments, for example, the electronic device 100 may be any of a call receiver, a wired telephone apparatus, a cellular telephone, a personal digital assistant (PDAs), a smart phone, a handheld or portable electronic device, a headset, a MP3 player, a battery-powered device, a wearable device, a radio, a navigation device, a laptop or notebook computer, a netbook, a pager, a PMP (personal media player), a DVR (digital video recorder), a gaming device, a camera, an e-reader, an e-book, a tablet device, or a similar mobile or computing device.

Specifically, device 100 represents a mobile device including a display 110. In one example the display 110 may be a touch screen. A user interface of the device 100 may include one or more microphones 105 and speakers 115. The user interface may also include buttons positioned as hard keys, soft keys, of displayed on the display 100 which may be touch sensitive.

The electronic device 100 may comprise various other configurations and still be within the scope of the present disclosure. The electronic device 100 is capable of changing its mode to a meeting mode in response to detecting usage of the connectivity identification information at the electronic device 100 during the meeting time. The detailed working of electronic device is explained with respect to the subsequent figures.

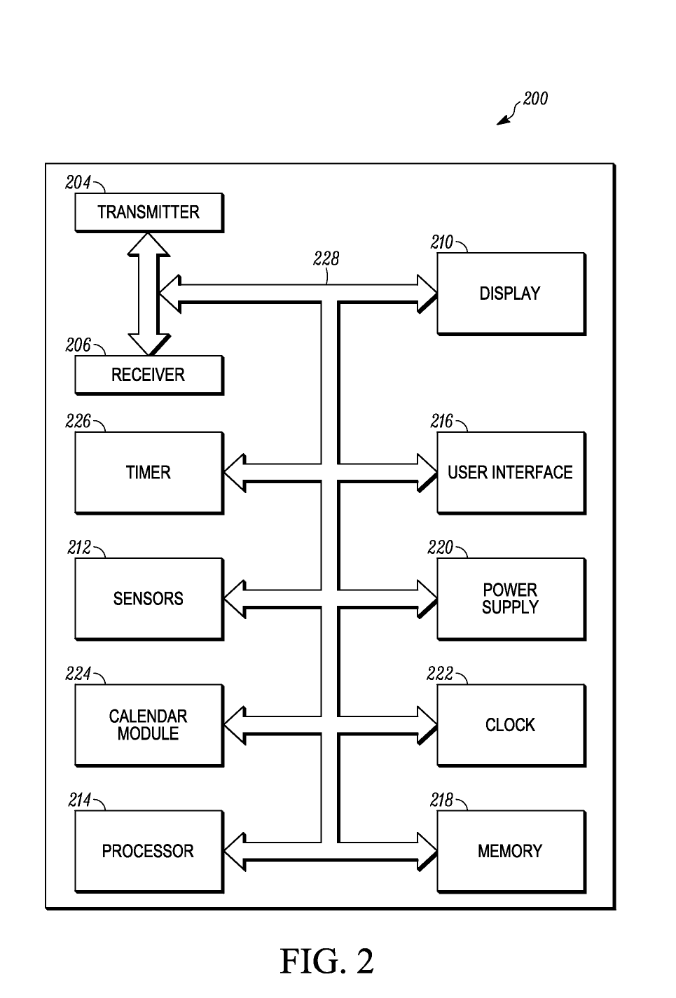

Referring to FIG. 2, there is provided a block diagram illustrating example internal hardware components 200 of the electronic device 100. The block diagram of the electronic device 100 includes various components. The example components 200 include a transmitter 204, a receiver 206, a display 210, sensors 212, a processor 214, a user interface 216, a memory 218, a power supply 220, a clock 222, a calendar module 224, and a timer 226, each capable of communicating with one or more components of the electronic device 100. For example, as shown in FIG. 2, all components are coupled to a bidirectional system bus 228, having one or more of a data communication path, a control communication path or a power supply path.

The transmitter 204 enables the electronic device 100 to transmit and the receiver 206 enables the electronic device 100 to receive RF signals through an antenna (not shown). In accordance with the embodiment, the receiver 206 converts the RF signals received from the antenna to digital data for use by the processor 214. Each transmitter 204 and/or the receiver 206 of the internal components 200 of the electronic device 100 utilizes wireless technology for communication, such as, but are not limited to, peer-to-peer or ad hoc communications such as Bluetooth, Zigbee, near field communication, infrared, peer-to-peer Wifi, wireless HDMI, wireless USB, HomeRF, and the like. The transmitter 204 and the receiver 206 shown in FIG. 2 also represent possible transceivers of the electronic device 100. In addition to the above described technologies, each wireless transceiver, transmitter and/or receiver may also utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants.

The display 210 may generate visual indications of data generated during operation of the processor 214. The visual indications may include prompts for user, calculated values, detected data, etc. The display device 210 may include one or more of the following components: a cathode ray tube, a liquid crystal display, a plasma display, an incandescent light, a fluorescent light, a front or rear projection display, or a light emitting diode indicator.

In accordance with an embodiment, the user interface 216 may be connected to the processor 214 for entering data and commands in the form of text, touch input, gestures, etc and for outputting various notifications. The user interface 216 may include a keyboard, microphone, speaker, alarm and/or buzzer, and/or a mechanical output component such as vibrating or motion-based. The user interface 216 enables a user of the electronic device 100 to interact with the device 100 by providing inputs or receiving device generated outputs.

Still referring to FIG. 2, the memory 218 may be used to store data and instructions for the operation of the processor 214. In the various embodiments, the memory 218 may be one or more separate components and/or may be partitioned in various ways for various purposes such as but not limited to, optimizing memory allocations, etc. Thus it is to be understood that the example memory 218 illustrated in FIG. 2 are for illustrative purposes only, for the purpose of explaining and assisting one of ordinary skill in understanding the various embodiments described herein.

Additionally, the power supply 220, such as a battery, may be included in the internal components 200 of the electronic device 100 for providing power to the other internal components 200 while enabling the electronic device 100 to be portable.

Furthermore, a calendar module 224 of FIG. 2 is configured to retrieve meeting events from various applications on the device 100 and store them. The meeting events may also be stored in the calendar module 224 directly by a user of the device. In another example, the calendar module 224 is populated with meeting events based on synchronization between the electronic device 100 and any other device belonging to the same user. In yet another example, the calendar module 224 stores meeting events when a user accepts a received meeting invite. The meeting events stored in the calendar module 224 also includes a meeting time which may further include a start time and an end time for the meeting event.

The internal components 200 further include sensors 212 may include accelerometers, gyroscope, or any other sensor that may be used to detect movement in the electronic device 100. The timer 226 is synchronized with the clock 222 and measures time intervals. In another embodiment, the timer 226 and the clock 226 may be integrated together.

Moreover, the processor 214 operates in conjunction with the data and instructions stored in the memory 218 to control the operation of the electronic device 100. The processor 214 may be implemented as a microcontroller, a digital signal processor, hard-wired logic and analog circuitry, or any suitable combination of these.

It is to be understood that FIG. 2 is for illustrative purposes only and is primarily for, although not solely for, explaining the information stored in memory for the various embodiments of an electronic device in accordance with the present disclosure, and is not intended to be a complete schematic diagram of the various components and connections for an electronic device. Therefore, an electronic device will comprise various other components not shown in FIG. 2, and/or have various other internal and external configurations, and still be within the scope of the present disclosure. Also, one or more of these components may be combined or integrated in a common component, or components features may be distributed among multiple components. Also, the components of the electronic device 100 may be connected differently, without departing from the scope of the invention.

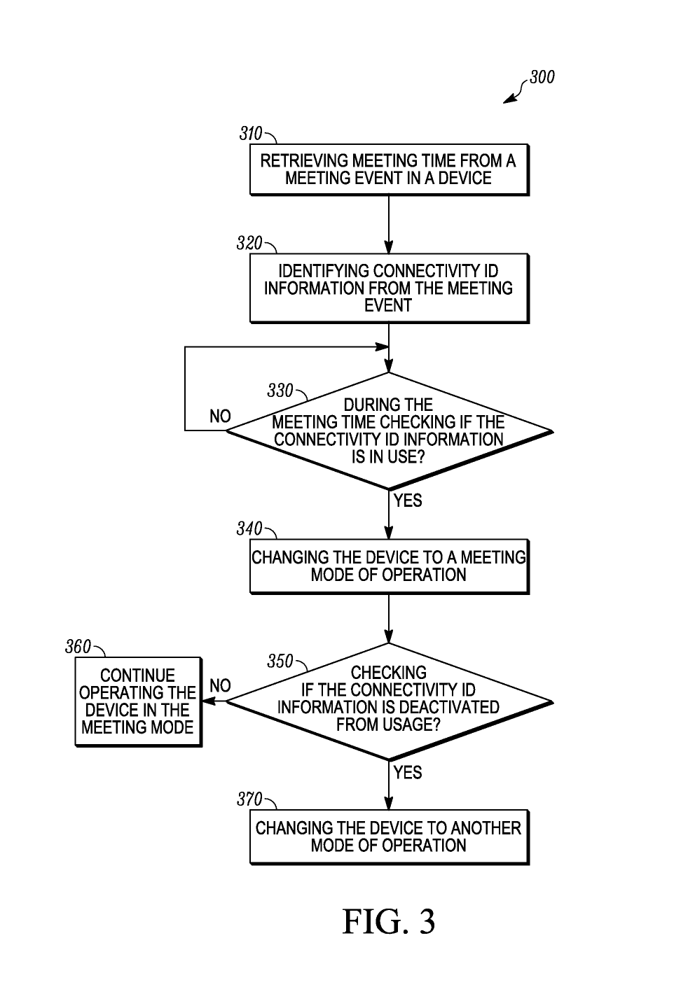

Referring to FIG. 3, there is provided a flow chart illustrating an implementation 300 of the electronic device 100. The method starts with the processor 214 retrieving 310 a meeting time from a meeting event stored in the calendar module 224 of the electronic device 100. The meeting time includes a start time, an end time for the meeting event, and therefore, also provides duration of the meeting event.

The processor 214, in conjunction with the calendar module 224 and memory 218, identifies 320 connectivity identification information from the meeting event. This information may be stored in the calendar module 224 or the memory 218. In another embodiment, the calendar module 224 may be implemented as part of the memory 218. The connectivity identification information is one of a conference call number, a telephone number, a user identification information, a video conference, or a web link to a virtual meeting. This information is provided in the meeting event and is to be used by the user of the electronic device 100 to participate in the meeting event.

Thereafter, the processor 214 checks whether the connectivity identification information is in use on the electronic device 100 during the meeting time retrieved from the meeting event. In one example, the meeting time retrieved is 3:30 pm to 4:30 pm on Jan. 28, 2014 and the connectivity information for the meeting event is a conference call number. Now in this example, the processor 214 of the electronic device 100 checks whether the identified conference call number is in use, i.e., dialed on the electronic device during the time meeting time 3:30 pm to 4:30 pm.

If the processor determines that the connectivity identification information is in use on the electronic device 100 during the meeting time then the processor 214 changes 340 the current mode of operation of the electronic device 100 to a meeting mode. In one example, the meeting mode may include inactivating electronic device 100 notifications of incoming calls and/or messages and notifying a calling party that the device is in a meeting. Other possible changes that may be pre-defined by the user of the device for the meeting mode are not out of the scope of this invention.

However, if the processor determines otherwise, i.e., if the connectivity identification information is not in use on the electronic device 100 during the meeting time then the processor 214 keeps operating the electronic device 100 in the current mode and keeps checking 330 during the meeting time.

After changing the device 100 to a meeting mode, the processor 214 checks 350 whether the connectivity identification information is deactivated from usage on the electronic device 100. If not, the processor 214 continues 360 to operate the device in the meeting mode. However, if it is determined that the connectivity identification information is deactivated from usage on the electronic device 100 then the processor 214 changes 370 the mode of the device 100 from the meeting mode to another mode of operation. In one example, the other mode may be the mode that was activate on the device before the processor 214 changed the device 100 to the meeting mode. In another example, the other mode may be a mode pre-defined by a user of the device.

Moreover, the process shown in FIG. 3 is repeated until the end of meeting time is reached. In other words, even after changing 370 the mode of the device 100 from the meeting mode to another mode of operation upon determining that the connectivity identification information is deactivated from usage on the electronic device 100, the processor 214 keeps checking whether the connectivity identification information is put in use again on the electronic device 100 during the meeting time, i.e., after the start of the meeting time and before the end of the meeting time.

The present invention provides significant advantages over the conventional methods. In the example mentioned above, if the conventional methods were used then the device will be put into a meeting mode from 3:30 pm to 4:30 pm i.e., the entire duration of the meeting. However, it may happen that the meeting actually started late and finished earlier than the scheduled time. But due to the conventional method, the device will be in the meeting mode for the entire duration and all incoming notifications may be put to silent during this period and the user may miss out on important incoming calls/messages, etc.

Therefore, by changing the mode of the device to a meeting mode based on meeting time as well as usage of connectivity identification information on the device, the device will be put in the meeting mode only for the actual duration of the meeting saving the user from significant inconvenience caused by the conventional technology.

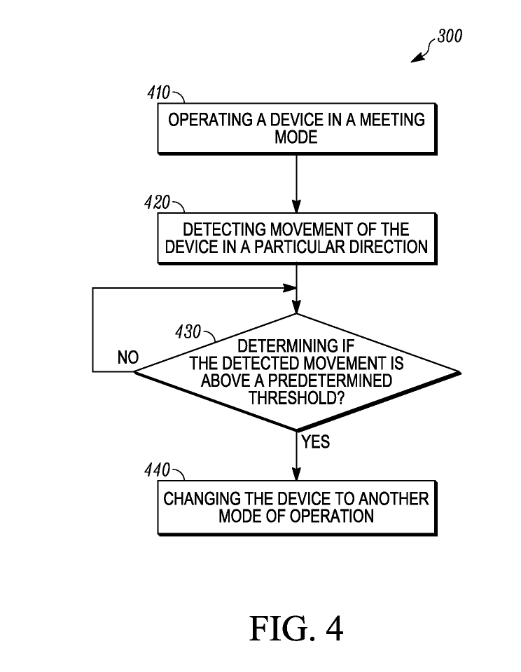

FIG. 4 is a flowchart showing example steps of another operation 400 of the electronic device 100 in accordance with some embodiments of the present invention. The method starts with the processor 214 of the device 100 operating 410 the device 100 in a meeting mode during a meeting event. In one example, the processor 214 may be operating the device 100 in a meeting mode based on the implementation 300 explained earlier with respect to FIG. 3.

While the device 100 is operating in the meeting mode, the sensors 212 detect 420 any movement of the device in a particular direction. The processor 214, in conjunction with the sensors 212, determines 430 if the movement detected by the processor is above a predetermined threshold. This predetermined threshold may be set by the user of the device 100 and may be different for different users. The users may set the predetermined threshold based on their understanding of their meeting spaces or any other criteria.

In case the processor 214 determines that the detected movement is below the predetermined threshold, it keeps performing the determining 430 step till the end of the meeting time. Otherwise, if and when the processor 214 determines that the detected movement is above the predetermined threshold, then the processor 214 changes 440 the device's 100 operating mode from the meeting mode to another mode of operation.

The method explained with respect to FIG. 4 provides an efficient way for changing the mode of the device from a meeting mode to another default mode. This is substantially advantageous over the convention technology which deactivates the meeting mode on the device only upon expiration of the meeting time. However, with the method described in FIG. 4, the meeting mode may be deactivated as soon as the user moves away substantially from a particular location where the meeting mode was in force.

For example, if the user is in a meeting being conducted in a conference room and the predetermined threshold is 2 miles. Then accordingly to the embodiment discussed in FIG. 4, the meeting mode on the user's device will be deactivated as soon as the user, along with the device, moves away 2 miles from the conference room. The method in FIG. 4 also provides provision for false trigger by using only the movement in one particular direction. Therefore, even though the user, with the device, might constantly be moving inside the conference room, the movement recorded in one particular direction will be below the threshold and the meeting mode will be continued on the device.

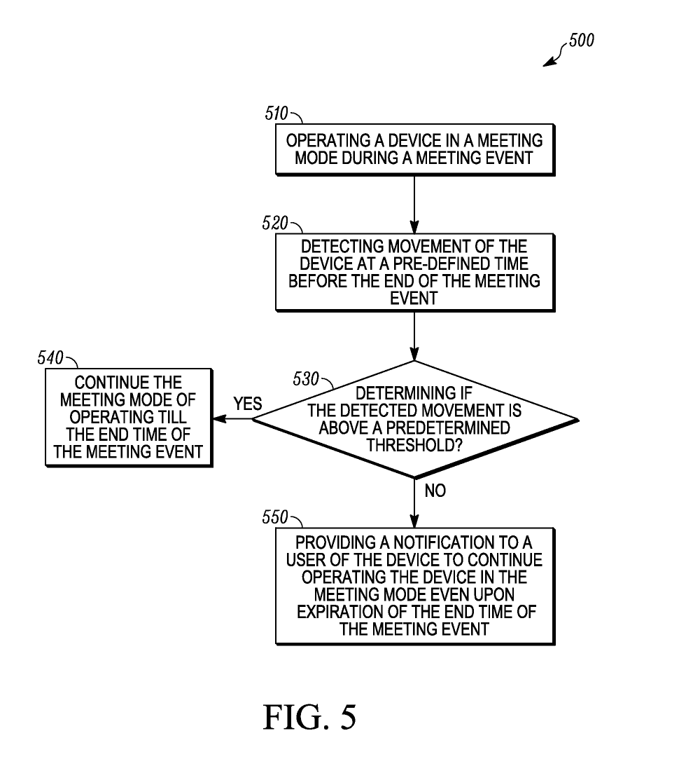

FIG. 5 is a flowchart showing example steps 500 of yet another operation of the electronic device 100 in accordance with some embodiments of the present invention. The method starts with the processor 214 of the device 100 operating 510 the device 100 in a meeting mode during a meeting event. In one example, the processor 214 may be operating the device 100 in a meeting mode based on the implementation 300 explained earlier with respect to FIG. 3.

While the device 100 is operating in the meeting mode, the sensors 212 in conjunction with the timer 226 detect 520 movement of the device 100 at a pre-defined time before the end of the meeting event. The processor 214, in conjunction with the sensors 212, determines 530 if the detected movement is above a predetermined threshold. This pre-defined time and predetermined threshold for movement may be set by a user of the device 100 based on his/her preferences.

In one embodiment shown in FIG. 5, if the processor 214 determines that the detected movement is above the predetermined threshold, it continues 540 the meeting mode on the device 100 until the end time of the meeting event and then deactivates the meeting mode. In another embodiment (not shown in FIG. 5), if the processor 214 determines that the detected movement is above the predetermined threshold, the processor 214 may loop back to the process discussed in FIG. 4 and determine 430 whether the movement detected is above the predetermined threshold. This predetermined threshold is set by the user of the device 100 and may be different for different users. As explained with respect to FIG. 4, if the processor 214 determines that the detected movement is below the predetermined threshold, it keeps the device 100 in the meeting mode of operation and continues performing the determining 430 step until the end of the meeting time. Otherwise, if the processor 214 determines that the detected movement is above the predetermined threshold, then the processor 214 changes 440 the device's 100 operating mode from the meeting mode to another mode of operation.

Referring back to FIG. 5, in case the processor 214 determines that the detected movement is below the predetermined threshold, then the processor 214 provides 550 a notification to the user of the device 100 to continue operating the device in the meeting mode even upon expiration of the end time of the meeting event. The notification may be displayed on the display 210 of the electronic device. In another example, the notification may be provided on any other wearable device of the user which in communication with the device 100. The notification may be visual or audio.

The method explained with respect to FIG. 5 provides an efficient way for continuing the meeting mode on the device even after the end time of the meeting event has expired. For example, if the user is in a meeting event scheduled from 2:00 pm to 2:30 pm and the user sets the pre-defined time as 5 minutes and the predetermined threshold for movement as 1 meter. Now, in accordance with the method disclosed in FIG. 5, the sensors 212 will detect movement of the device at 2:25 pm i.e., 5 minutes before the end time of the meeting. If the detected movement is above 1 meter, the processor will continue the meeting mode until 2:30 pm. Otherwise, if the detected movement is below 1 meter, the user of the device will be provided with a notification to continue operating the device in the meeting mode even upon expiration of the end time of the meeting event.

Upon receiving the notification, the user may accept or decline the provided option. In one example, if the user accepts to continue operating the device in the meeting mode even upon expiration of the end time of the meeting event, then the user will have to later manually exit the meeting mode whenever the user wishes to do so. However, if the user declines to continue operating the device in the meeting mode even upon expiration of the end time of the meeting event, then the meeting mode will be de-activated at the expiration of the end time of the meeting event, i.e., 2:30 pm.

This method is substantially advantageous over the convention technology which deactivates the meeting mode on the device only upon expiration of the meeting time. The method of FIG. 5 allows the device to operate in the meeting mode even upon expiration of the meeting time based on the determination that the user along with the device has not moved away from the meeting place even when the meeting end time is approaching.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method in an electronic device for managing modes of the electronic device, the method comprising:
retrieving a meeting time from a meeting event stored in a scheduling application of the electronic device;
identifying connectivity identification information from the meeting event; and
changing the electronic device to a meeting mode in response to detecting usage of the connectivity identification information at the electronic device during the meeting time.

2. The method of claim 1, wherein the connectivity identification information is at least one of a conference call number, a telephone number, a user identification information, a video conference, or a web link to a virtual meeting.

3. The method of claim 1, wherein the meeting mode includes at least one of inactivating electronic device notifications of incoming calls and/or messages and notifying a calling party.

4. The method of claim 1, wherein the meeting time includes a start time and an end time of the meeting event.

5. The method of claim 4 further comprising:
detecting movement below a threshold level of the electronic device within a pre-defined time before the end time of the meeting event; and
providing a notification to a user of the electronic device in response to detecting the movement below the threshold level.

6. The method of claim 5, wherein the notification provides an option to the user of the electronic device to keep the electronic device in the meeting mode in response to the expiration of the end time of the meeting event.

7. The method of claim 5, wherein the pre-defined time is set by the user of the electronic device.

8. The method of claim 1 further comprising:
detecting movement of the electronic device in a particular direction; and
changing the electronic device from the meeting mode to another mode of operation before the expiration of the meeting time in response to determining that the detected movement of the electronic device is above a predetermined threshold.

9. The method of claim 8, wherein the predetermined threshold is set by the user of the electronic device.

10. The method of claim 1 further comprising:
changing the electronic device from the meeting mode to another mode of operation before the expiration of the meeting time in response to detecting non-usage of the connectivity identification information at the electronic device during the meeting time.

11. An electronic device for managing modes of the electronic device, the electronic device comprising:
a calendar module configured to store at least one meeting event, wherein the at least one meeting event includes a meeting time; and
a processor configured to retrieve the meeting time from the meeting event stored in the calendar module, identify connectivity identification information from the meeting event, and change the electronic device to a meeting mode in response to detecting usage of the connectivity identification information at the electronic device during the meeting time.

12. The electronic device of claim 11, wherein the connectivity identification information is at least one of a conference call number, a telephone number, a user identification information, a video conference, or a web link to a virtual meeting.

13. The electronic device of claim 11, further comprising an output component, wherein the meeting mode includes inactivating electronic device notifications by the output component of incoming calls and/or messages.

14. The electronic device of claim 11, wherein the meeting time includes a start time and an end time of the meeting event.

15. The electronic device of claim 14 further comprising:
a sensor configured to detect movement of the electronic device within a pre-defined time before the end time of the meeting event,
wherein the processor is further configured to provide a notification to a user of the electronic device at the display in response to detecting movement below threshold level of the electronic device by the sensor.

16. The electronic device of claim 15, wherein the notification provides an option to the user of the electronic device to keep the electronic device in the meeting mode in response to the expiration of the end time of the meeting event.

17. The electronic device of claim 15, wherein the pre-defined time is set by the user of the electronic device.

18. The electronic device of claim 11 further comprising:
a sensor configured to detect movement of the electronic device in a particular direction,
wherein the processor is further configured to change the electronic device from the meeting mode to another mode of operation before the expiration of the meeting time in response to determining that the detected movement of the electronic device is above a predetermined threshold.

19. The electronic device of claim 18, wherein the predetermined threshold is set by the user of the electronic device.

20. The electronic device of claim 11 wherein the processor is further configured to change the electronic device from the meeting mode to another mode of operation before the expiration of the meeting time in response to detecting non-usage of the connectivity identification information at the electronic device during the meeting time.
